(19) United States
(12) Patent Application Publication
(10) Pub. No.: US 2015/0168703 A1
(43) Pub. Date: Jun. 18, 2015

(54) SYSTEM, METHOD AND COMPUTER-ACCESSIBLE MEDIUM FOR PROVIDING FLUORESCENCE ATTENUATION

(71) Applicant: The Trustees of Columbia University in the City of New York, New York, NY (US)

(72) Inventors: Lu Wei, Anhui (CN); Zhixing Chen, Beijing (CN); Wei Min, Edgewater, NJ (US)

(21) Appl. No.: 14/402,041

(22) PCT Filed: May 17, 2013
(86) PCT No.: PCT/US2013/041553

§ 371 Date: Nov. 18, 2014

Related U.S. Application Data
(60) Provisional application No. 61/648,706, filed on May 18, 2012.
(60) Provisional application No. 61/716,939, filed on Oct. 22, 2012.

(51) Int. Cl. G02B 21/00; G01N 21/64

(52) U.S. Cl. CPC G02B 21/0076; G01N 21/6408; G01N 2021/6415; G01N 2201/06113

(57) ABSTRACT

Exemplary system, method and computer-accessible medium that can include at least one radiation arrangement that can generate a first radiation and a second radiation, and a microscope that can receive a first excited fluorescence based on the first radiation and a second excited fluorescence based, at least in part, on the second radiation. A computer hardware arrangement can generate an image based on the first excited fluorescence and the second excited fluorescence.

### CROSS-REFERENCE TO RELATED APPLICATION(S)

The present application relates to and claims priority from U.S. Provisional Application Ser. Nos. 61/648,706 filed on May 18, 2012, and 61/716,939 filed on Oct. 22, 2012, the entire disclosures of which are incorporated herein by reference.

### FIELD OF THE DISCLOSURE

The present disclosure relates generally to systems, methods and computer-accessible medium for multi-photon fluorescence imaging, and more specifically, relates exemplary systems, methods and computer-accessible medium fluorescence attenuation microscopy in fluorescence imaging.

### BACKGROUND INFORMATION

Advances in optical imaging techniques have revolutionized studies of biological structures and functions on microscopic scales. For a given optical imaging modality, the spatial resolution and the penetration depth can have two important technical parameters. While the diffraction limited spatial resolution has been broken by a few seminal techniques such as stimulated emission depletion microscopy (“STED”) (see, e.g., References 1-3), currently, the penetration depth for living organisms can be exhibited by two-photon (“2P”) microscopy, which can provide high-resolution (e.g., sub-cellular) images deep within scattering samples. (See, e.g., Reference 4). Due to the nonlinear intensity dependence of the absorption, 2P excited fluorescence can be mostly generated from the laser focus. Such spatially confined excitation likely facilitates an efficient capture of the emitted and subsequently scattered fluorescence by a large-area detector without a confocal pinhole, which dramatically promotes the detection sensitivity deep within scattering samples. (See, e.g., Reference 5). As such, 2P microscopy can be an indispensable tool in the arsenal of biophotonics. (See, e.g., Reference 6).

2P microscopy, however, can still be constrained by a fundamental imaging-depth limit for scattering samples. (See, e.g., Reference 7). This depth limit for most cases may not be limited by the available laser power, but rather by the obtainable image contrast. (See, e.g., References 7-11). As shown in FIG. 1A, the 2P image of fluorescent beads 105 embedded in a turbid 3D sample gradually fades away with depth. The corresponding depth limit can likely not be the true maximum. When the laser power can be increased accordingly, images can be acquired much deeper. However, the image contrast deteriorates with depth as shown in FIG. 1B. Eventually, it may no longer be feasible to identify the target beads from the overwhelming background 110, regardless of how much laser power can be applied. As an example, for mouse brain tissues expressing green fluorescent protein (“GFP”), the corresponding depth limit can be about 1 mm. (See, e.g., Reference 8). Although this depth can be impressive compared with other high-resolution techniques, it still can only cover a very small fraction of the mammalian brain.

Such fundamental imaging-depth limit can arise because, as the incident laser power increases with imaging depth in order to maintain the same excitation power at focus, the conventional wisdom that 2P fluorescence can be generated only within the focal volume may no longer holds. (See, e.g., Reference 7). Eventually, the fluorescence from out-of-focus fluorophores 115 (e.g., those located near the sample surface) can grow and dominate the detected signal. (See, e.g., FIG. 1C). The fundamental imaging-depth limit can be defined, for example as follows:

$${( \frac{S}{B} )}_{2 P} = \frac{{\int }_{{V}_{in}}^{ } {\int }_{0}^{τ} {C}_{S} ( r , z ) {I}^{2} ( r , z , t ) d t d V}{{\int }_{{V}_{out}}^{ } {\int }_{0}^{τ} {C}_{B} ( r , z ) {I}^{2} ( r , z , t ) d t d V} = 1 \qquad ( 1 )$$

where Vᵢₙ can be the focal volume, Vₒᵤₜ can be the total sample volume along the beam path but excluding the focal volume, r can be the distance from the optical axis, z can be the axial distance from the tissue surface, C can be the local fluorophore concentration, I can be the laser intensity, and τ can be the pixel dwell time during the imaging. As an analogy, the limited imaging-depth can be reminiscent to the scenario of wide-field fluorescence microscopy, which can lack background rejection.

This fundamental depth limit likely cannot be overcome by further increasing the laser power, which can unbiasedly enhance both signal and background. Since the loss of intensity due to sample scattering can be the physical origin of the imaging-depth limit, it can be used to design and tailor incident waves that can experience less scattering within a given turbid sample. Extensive efforts have been made along this wave-based strategy, such as adaptive optics (see, e.g., References 12 and 13), imaging with longer excitation wavelengths (see, e.g., Reference 9), optical phase conjugation (see, e.g., Reference 14) and differential aberration imaging. (See, e.g., Reference 15). However, these methods have not provided significant improvement over current methods.

Thus, it may be beneficial to provide exemplary systems, methods and computer-accessible mediums that can extend the fundamental depth limit of 2P fluorescence imaging, and to provide other solutions, which can overcome at least some of the deficiencies described herein above.

### SUMMARY OF EXEMPLARY EMBODIMENTS

Exemplary embodiments of the present disclosure relate to systems and methods of using stimulated emission attenuations microscopy in fluorescence imaging whereby the depth limit can be expanded by performing stimulated emission attenuation microscopy in which the two-photon excited fluorescence at the focus can be switched on and off by a modulated and focused laser beam that can be capable of inducing stimulated emission of the fluorophores from the excited states. The resulting image, constructed from the induced fluorescence attenuation signal, exhibits a significantly improved signal-to-background contrast owing to its overall higher-order nonlinear dependence on the incident laser intensity. For brain tissues, the exemplary system, method and computer-accessible medium, according to an exemplary embodiment of the preset disclosure, can extend the imaging depth limit of two-photon fluorescence microscopy by a factor of more than 1.8.

According to an exemplary embodiment of the present disclosure, it can be possible to use the exemplary system, method and computer-accessible medium, a scheme that combines a continuous wave (“CW”) stimulated emission (“SE”) beam can be employed collinearly with 2P beam and detects the fluorescence attenuation signal. For example, SE beam can be selected with proper wavelength and intensity to preferentially switch off the fluorescence signal from the focus while keeping most of the out-of-focus background fluorescence less affected, the exemplary system, method and computer-accessible medium, according to an exemplary embodiment of the present disclosure, can enhance the image contrast of in-focus signal over out-of-focus background, effectively extending the fundamental imaging depth limit. These and other objects of the present disclosure can be achieved through exemplary embodiments of exemplary systems, methods and computer-accessible mediums which can generate an image of an objected using stimulated emission microscopy. Such exemplary systems, methods and computer-accessible mediums can be performed, for example, by receiving a first information corresponding to a first excited fluorescence of the object(s), receiving a second information corresponding to a second excited fluorescence of the object(s), and determining a third information based on the first information and the second information.

According to some exemplary embodiments of the present disclosure, the first excited fluorescence can be generated by a first radiation arrangement and the second excited fluorescence can be generated by a combination of the first radiation arrangement and the second radiation arrangement. The first radiation arrangement can be a two-photon laser, and the second radiation arrangement can be a two-photon laser or a stimulated emission laser, which can be a continuous wave stimulated emission laser and/or a pulsed stimulated emission laser. The first excited fluorescence can be generated by a radiation arrangement at a first intensity and the second excited fluorescence can be generated by the radiation arrangement at a second intensity. The first intensity can be higher or lower than the second intensity. The third information can be determined by subtracting the second information from the first information and/or by subtracting the first information from the second information. The third information can also be determined by dividing the first information by the second information and/or by dividing the second information by the first information. The third information can also be determined using a lock-in amplifier configured to block and unblock the second excited fluorescence at a particular frequency. The first information and the second information can be generated using a multi-photon microscope, which can include a widely tunable pulsed laser.

In a further exemplary embodiment of the present disclosure are methods and systems for generating an image of at least one object using a fluorescence microscopy procedure. Such exemplary methods and systems can be performed by, for example, providing a first radiation. A first excited fluorescence of the object(s) based on the first radiation can be received. A second radiation can be provided, and a second excited fluorescence of the object(s) based at least in part on the second radiation can be received. An image of the object(s) can be generated based on the first excited fluorescence and the second excited fluorescence.

According to some exemplary embodiments, the first radiation and the second radiation can be generated by a single radiation arrangement. The radiation arrangement can be a two-photon laser, and the first radiation can be generated at a first intensity and the second radiation can be generated at a second intensity. The first intensity can be higher or lower than the second intensity. The first radiation can be generated by a two-photon laser and the second radiation can be generated by a two-photon laser or a continuous wave stimulated emission laser. In further exemplary embodiments, the second excited fluorescence can be based on the first radiation and the second radiation. The image can be generated by subtracting the second excited fluorescence from the first excited fluorescence. The first excited fluorescence and the second excited fluorescence can be received by a multi-photon microscope, which can include a widely tunable pulsed laser.

These and other objects, features and advantages of the present disclosure will become apparent upon reading the following detailed description of exemplary embodiments of the present disclosure, when taken in conjunction with the appended drawings and claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIGS. 1A-1C are exemplary illustrations of the fundamental imaging-depth limit of standard two-photon microscopy;

FIG. 2A is an exemplary Jablonski diagram of a typical fluorophore under two-photon excitation and one-photon simulated emission according to an exemplary embodiment of the present disclosure;

FIG. 2B is an exemplary graph of the intensity dependence of fluorescence attenuation and residual fluorescence on the SE beam according to an exemplary embodiment of the present disclosure;

FIG. 3 is an exemplary representation of a principle being applied by the exemplary system, method and computer-accessible medium according to an exemplary embodiment of the present disclosure;

FIGS. 4A-4C are various exemplary designs and graphs being applied by the exemplary system, method and computer-accessible medium according to exemplary embodiments of the present disclosure;

FIGS. 5A-5D are graphical comparisons of an exemplary fundamental imaging-depth limit between the regular two-photon imaging and being applied by the exemplary system, method and computer-accessible medium according to an exemplary embodiment of the present disclosure;

FIG. 6 is an exemplary flow diagram for generating an image according to an exemplary embodiment of the present disclosure;

FIGS. 7A and 7B are exemplary images of an exemplary first fluorescence excitation according to an exemplary embodiment of the present disclosure;

FIGS. 7C and 7D are exemplary images of an exemplary second fluorescence excitation according to an exemplary embodiment of the present disclosure;

FIGS. 7E and 7F are exemplary images of an exemplary image generation according to an exemplary embodiment of the present disclosure; and

FIG. 8 is an illustration of an exemplary block diagram of an exemplary system in accordance with certain exemplary embodiments of the present disclosure.

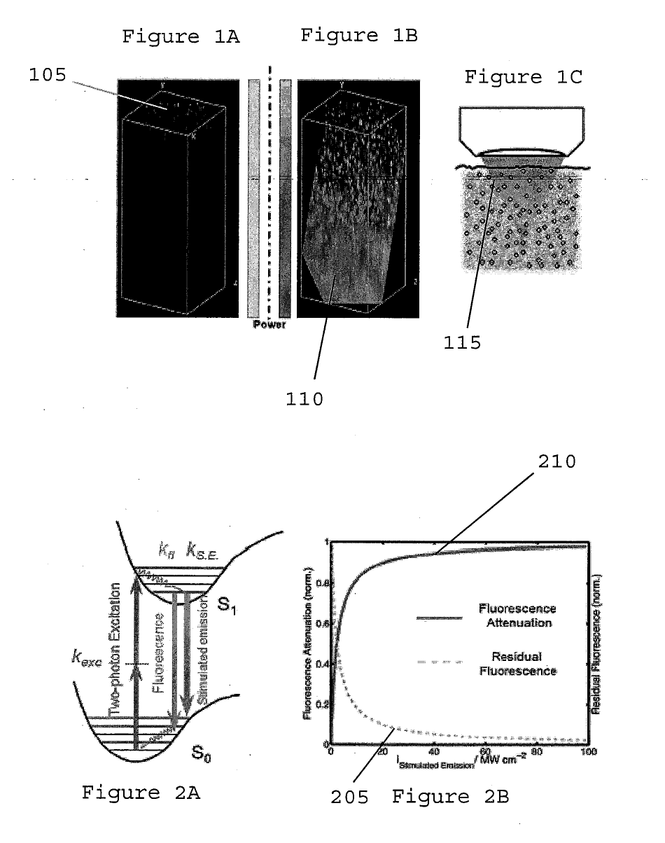

Throughout the drawings, the same reference numerals and characters, unless otherwise stated, are used to denote like features, elements, components, or portions of the illustrated embodiments. Moreover, while the present disclosure will now be described in detail with reference to the Figures, it is done so in connection with the illustrative embodiments and is not limited by the particular embodiments illustrated in the Figures.

### DETAILED DESCRIPTION OF EXEMPLARY EMBODIMENTS

### 1. Discussion

### 1.1. Laser Intensity Distribution Inside Scattering Samples

For standard 2P imaging, it can be important to determine how the laser intensity can be distributed within a scattering sample when the depth limit can be reached. Fluorophores can normally be distributed throughout a three-dimensional (“3D”) volume of the sample. Thus, the number of out-of-focus fluorophores can likely be orders-of-magnitude larger than that those of the in-focus. For example:

$$\frac{{\int }_{{V}_{in}}^{ } {C}_{S} ( r , z ) d V}{{\int }_{{V}_{out}}^{ } {C}_{B} ( r , z ) d V} << 1 \qquad ( 2 )$$

A comparison between Eq. (1) and Eq. (2) can indicates that, for example, despite the scattering loss I² (r, z) at the focus can be much larger than its out-of-focus counterpart when the depth limit can he reached as (IPFined in Eq. (1). In a simplified condition with a homogeneous fluorophore distribution, for example, C_{B} (r, z)=Cs (r, z), ∫∫I² (r, z,t)ddv can be equal between the background and the signal. Consequently, the integral of I² (r, z) over a subset of the out-of-focus volume can also be smaller than that over the focus.

### 1.2. Exemplary Fluorescence Attenuation in a Presence of Stimulated Emission

It can be important to quantify the fluorescence attenuation effect when combining a CW SE beam collinearly with a 2P excitation beam, and focusing them into a common focal spot. Assuming no fluorescence saturation or photobleaching, provided below are exemplary photophysical schemes of 2P fluorescence with and without the SE beam, which can be analyzed.

For example, in the absence of the SE beam, the following can apply:

$${S}_{0} + 2 {hv}_{exc} {}^{{k}_{exc}} {S}_{1}$$

$${S}_{1} {}^{{k}_{fl}} {S}_{0} + {hv}_{fl}$$

In the presence of the SE beam, the following, for example, can apply:

$${S}_{0} + 2 {hv}_{exc} {}^{{k}_{exc}} {S}_{1}$$

$$\{ \begin{matrix}{S}_{1} {}^{{k}_{fl}} {S}_{{0}_{1}} + {hv}_{fl} \\ {S}_{1} + h {v}_{S . E .} {}^{{k}_{S . E .}} {S}_{{0}_{2}} + 2 {hv}_{S . E .}\end{matrix}$$

where S₀ and S₁ can represent the ground and excited state, respectively, h v can be the energy of a single photon k_{exc}=σ_{exc} (I_{exc}λ_{exc}/hc)² can be the 2P excitation rate, σ_{exc} can be the 2P absorption cross-section of the molecule at λ_{exc}, I_{exc} can be the intensity of the 2P excitation bean (e.g., in W/cm²). The fluorescence emission rate k_{fl} can be a constant for a given fluorophore: k_{fl}=l/τ_{fl}, where τ_{fl} can be the fluorescence lifetime. In the case of SE, k_{SE}=σ_{SE}I_{SE}λ_{SE}/hc can be the SE rate where σ_{SE} can be the SE cross-section of the molecule at λ_{SE}. Thus, the 2P fluorescence emission rate of a single fluorescent molecule (R) and its counterpart in the presence of SE attenuation (R′) can be determined, for example, as follows:

$$\begin{matrix}R = {f}_{rep} {k}_{exc} {τ}_{exc} η & ( 3.1 ) \\ {R}^{′} = {f}_{rep} {k}_{exc} {τ}_{exc} {η}^{′} = {f}_{rep} {k}_{exc} {τ}_{exc} η \frac{{k}_{fl}}{{k}_{fl} + {k}_{S . E .}} & ( 3.2 )\end{matrix}$$

where fᵣₑₚ can be the repetition rate of the excitation pulse train, τ_{exc} can be the pulse with approximately 100 fs for a typical 2P laser, η can be the fluorescence quantum yield, and η′can be effective fluorescence quantum yield in the presence of the SE beam. Subtracting Eq. (3.2) from Eq. (3.1), the fluorescence attenuation rate defined as R_{STEAM} can be obtained, for example, as follows:

$${R}_{STEAM} = R - {R}^{′} = {f}_{rep} {k}_{exc} {τ}_{exc} η \frac{{k}_{S . E .}}{\text{?} + \text{?}} \\ \text{?} \text{indicates text missing or illegible when filed} \qquad ( 4 )$$

R_{STEAM}, which can be different from the commonly known STED signal, in which the residual fluorescence 205 can decrease while the SE beam intensity can increase with the intensity of an exemplary SE beam (see e.g., FIG. 2B) due to its differential nature. In contrast, FIG. 2A shows a simplified Jablonski diagram of a typical fluorophore under two-photon excitation and one-photon stimulated emission from its excited state where S₀ can be the ground state of the fluorophore and S₁ can be the excited state of the fluorophore, k_{exc} can be the two-photon excitation process, k_{fl} can be the fluorescence emission process from the excited state, and kₛₑ can be the competitive relaxation process due to a stimulated emission.

### 1.3. Imaging Contrast of STEAM

Taking R_{STEAM} in Eq. (4) back into Eq. (1), the image contrast (S/B)_{STEAM} of the exemplary system, method and computer-accessible medium in the differential imaging mode can be, for example, as follows:

$${( \frac{S}{B} )}_{STEAM} = \frac{{\int }_{{V}_{in}}^{ } {\int }_{0}^{τ} {C}_{S} ( r , z ) \frac{α {I}_{S . E .} ( r , z )}{1 + α {I}_{S . E .} ( r , z )} {I}_{exc}^{2} ( r , z , t ) d t d V}{{\int }_{{V}_{out}}^{ } {\int }_{0}^{τ} {C}_{B} ( r , z ) \frac{α {I}_{S . E .} ( r , z )}{1 + α {I}_{S . E .} ( r , z )} {I}_{exc}^{2} ( r , z , t ) d t d V} \qquad ( 5 )$$

where α≡τ_{fl}σ_{SE}λ_{SE}/hc. For many red fluorophores, λ_{SE} and λ_{exc} can be chosen to be close or even identical to each other. Consequently, 2P and SE beams can both lie within the optical transparent window (e.g., 650˜1300 nm), and can experience similar attenuation effect inside scattering samples. As analyzed earlier, I_{exc} (r, z, t) at the focus can be much higher than their out-of-focus counterparts can. Therefore, by introducing a new exemplary factor of αI_{SE} (r, z)/[1+αI_{SE}(r, z)], which can facilitate the intensity ratio between the in focus and out-of-focus part even larger, the molecules in the focus, but not in the background, can be switched off, and an improved signal-to-background contrast can be achieved at the original 2P imaging depth limit with the exemplary system, method and computer-accessible medium (e.g., (S/B)_{STEAM}>(S/B)_{2P}=1).

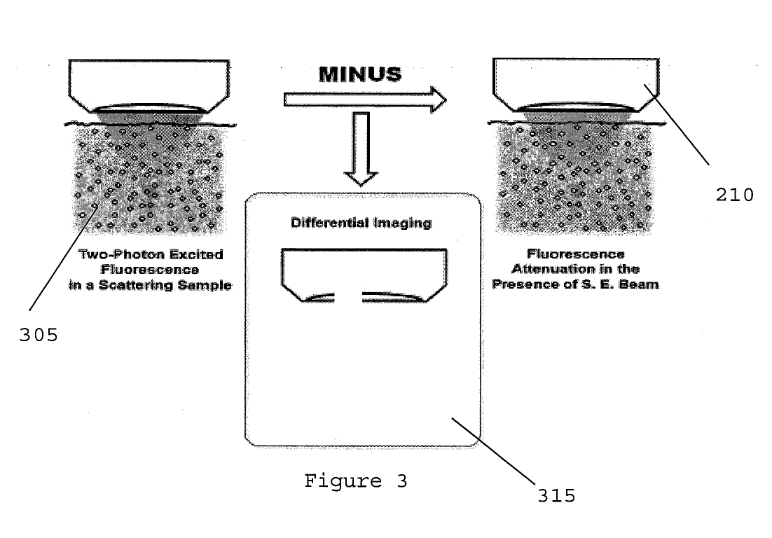

An exemplary illustration shown in FIG. 3 visually presents a principle of the exemplary system, method and computer-accessible medium. By subtracting the residual 2P fluorescence signal 310 (e.g., in the presence of SE beam) from the original 2P fluorescence signal 305 (e.g., without the SE beam) at each point, fluorescence attenuation can be generated at focal point, which can enhance the image contrast 315.

### 1.4. Imaging Contrast Dependence of SE Intensity I S.E.

The image contrast obtained using the exemplary system, method and computer-accessible medium, according to an exemplary embodiment of the present disclosure, can depend on the applied SE beam intensity I_{SE}. When I_{SE} can be very large, it can lead to αI_{SE} (r, z)/[1+αI_{SE}(r, z)]˜1 in Eq. (5), which can result in (S/B)_{STEAM}>(S/B)_{2P=}1. This can be due to the switching-off effect which can become unbiased for fluorophores in the focus and at background with no further contrast improvement being achieved at these intensities. When the exemplary fluorescence attenuation can be in the linear (e.g., non-starting) condition, more specifically, when αO_{SE(r, z)<}1 and the fluorescence attenuation can be beyond the shot noise, (S/B)_{STEAM} can become, for example, as follows:

$${( \frac{S}{B} )}_{STEAM} \approx \frac{{\int }_{{V}_{in}}^{ } {\int }_{0}^{τ} {C}_{S} ( r , z ) {I}_{S . E .} ( r , z , ) {I}_{exc}^{2} ( r , z , t ) d t d V}{{\int }_{{V}_{out}}^{ } {\int }_{0}^{τ} {C}_{B} ( r , z ) {I}_{S . E .} ( r , z ) {I}_{exc}^{2} ( r , z , t ) d t d V} > 1 \qquad ( 6 )$$

Eq. (6) provides an exemplary explanation underlying the exemplary system, method and computer-accessible medium. When operating above the shot noise of both the signal and the background with long enough signal acquisition time, the exemplary system, method and computer-accessible medium, according to an exemplary embodiment of the present disclosure, can transform the original 2P non-linear process into an overall three-photon process by adding a SE laser beam instead of another virtual state. The ascending of this high-order nonlinearity can improve the S/B ratio thereby improving the contrast and extending the imaging depth into scattering samples.

### 2. Exemplary Designs

### 2.1. Exemplary STEAM Fluorophores

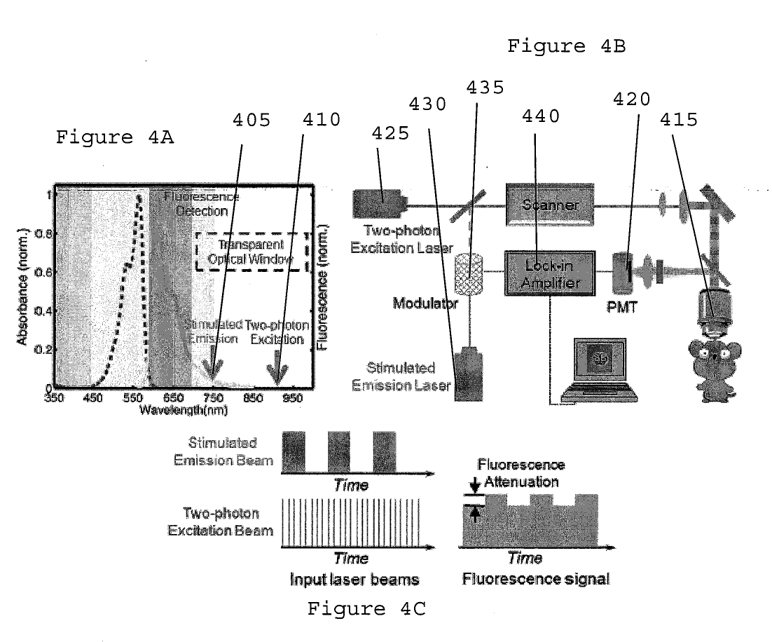

Some or all of the exemplary fluorophores studied with STED microscopy can be used in the exemplary system, method and computer-accessible medium. Fluorophores having high 2P absorption cross-section, high brightness, and broad and red-shifted emission spectra can be particularly suitable. FIG. 4A shows an exemplary graph with the absorption and emission spectra for an applicable red-emitting fluorophore 405, overlaid with the 2P excitation wavelength 410, SE wavelength and the spectral window for fluorescence collection. As described in a prior publication (see, e.g., Reference 18), fluorophores excited via 2P processes can be forced back to the ground state via one-photon STED in the near IR region. Exemplary selected wavelengths of SE beam and 2P excitation beam can be close to each other and both within transparent optical window, making them likely behave similarly in terms of the scattering effect.

### 2.2. Exemplary STEAM Microscope Setup

FIG. 4B shows a diagram of the exemplary system, method and computer-accessible medium according to exemplary embodiments of the present disclosure. For example, a 2P fluorescence microscope 415 can be equipped with a widely tunable pulsed laser (e.g., a two-photon excitation laser) and a non-descanned photomultiplier tube (“PMT”) 420 detector that can be closely attached to the objective to maximize the collection efficiency. Collinearly combined with the 2P laser beam 425, a CW SE laser beam 430 can be intensity modulated by a modulator 435 at a high frequency (e.g., approximately 5 MHz).

The exemplary fluorescence attenuation signal induced at the modulation frequency can be picked out and/or detected by a lock-in amplifier 440, which can be connected after the PMT 420. The exemplary designed pulse train of 2P beam 425, CW SE beam 430 and the resulting exemplary fluorescence attenuation signal are illustrated in the exemplary graphs provided in FIG. 4C.

### 3. Exemplary Numerical Simulation

As provided in Eq. (6), for example, a non-saturating condition of SE, the exemplary system, method and computer-accessible medium, according to an exemplary embodiment of the present disclosure, can be used to attain (S/B)_{STEAM}>(S/B)_{2P}=1 by imaging fluorescence attenuation at the imaging-depth limit of the regular 2P microscopy defined in Eq. (1). One of the advantages of the exemplary system, method and computer-accessible medium in deep tissue imaging can be seen by, for example, numerical simulation. The exemplary numerical simulation can be performed using, for example, the software Matlab, although not limited thereto.

### 3.1. Available Laser Power Inside Scattering Sample.

For a propagating Gaussian beam, the z-dependent beam area, A(z), can be, for example, as follows:

A(z)∝1+[(z−z_{focal})/z_{R}]² (7)

where z_{R}=πω₀²/λ can be the Rayleigh range, ω₀ can be the beam waist, and z_{focal} denotes the focal depth below the sample surface (z=0). Z_{R}=0.5 μm or a typical microscope objective can be adopted. When focusing the exemplary 2P beam and the exemplary SE beam deep into the scattering sample, the ballistic part of the Gaussian beam can follow a Lambert-Beer-like exponential decline with imaging depth. The area-integrated light power at certain z depth below surface thus can be described, for example, as follows:

P_{ballistic}(z)=P₀e^{-s/L,} (8)

where P₀ can be the light power at sample surface, and L_{S} can be the mean free path length describing the strength of the sample scattering; for example, L_{S}˜200 μm for brain tissues in the near IR region. (See, e.g., Reference 5).

### 3.2. The Imaging Depth Limit of Regular Two-Photon Microscopy.

Assuming uniformly fluorophore-stained sample and uniformly distributed laser intensity for each z layer, dt, dr can be integrated first in Eq. (1) for regular 2P imaging case, for example, as follows:

$$\begin{matrix}{( \frac{S}{B} )}_{2 P} \approx \frac{{\int }_{{z}_{in}}^{ } {\int }_{0}^{r ( z )} {I}_{ballistic}^{2} ( r , z ) d r d z}{{\int }_{{z}_{out}}^{ } {\int }_{0}^{r ( z )} {I}_{ballistic}^{2} ( r , z ) d r d z} \\ \approx \frac{{\int }_{{z}_{in}}^{ } [ {( \frac{{P}_{ballistic} ( z )}{A ( z )} )}^{2} A ( z ) ] d z}{{\int }_{{z}_{out}}^{ } [ {( \frac{{P}_{ballistic} ( z )}{A ( z )} )}^{2} A ( z ) ] d z}\end{matrix} \qquad ( 9 )$$

By defining Q(z)_{2P}≡[P_{ballistic}(z)/A(z)]² A(z) and plugging in A(z) and P_{ballistic}(z) in Eqs. (7) and (8), the following can be obtained, for example:

$${Q ( z )}_{2 P} ∝ \frac{exp ( - 2 z / {L}_{s} )}{1 + {[ ( z - {z}_{focal} ) / {z}_{R} ]}^{2}} \qquad ( 10 )$$

To determine the corresponding z_{focal} limit that can achieve S/B=1, both the fluorescence signal around and out of the focus can be numerically integrated, for example, as follows:

$${( \frac{S}{B} )}_{2 P} \approx \frac{{\int }_{{z}_{focal} - ɛ}^{{z}_{focla} + ɛ} {Q ( z )}_{2 P} d z}{{\int }_{0}^{{z}_{focla} - ɛ} {Q ( z )}_{2 P} d z} = 1 \qquad ( 11 )$$

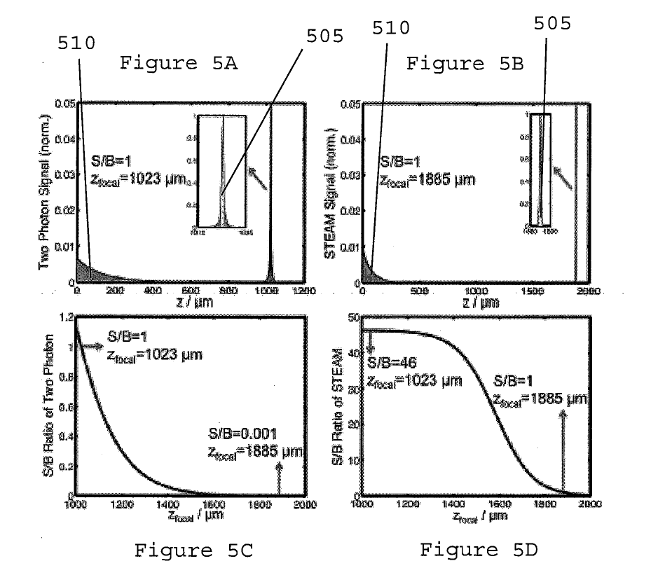

As shown in the exemplary graphs of FIGS. 5A-5D, by assigning ε=1 μm, which can be about 2 times of full width half maximum (“FWHM”) of the signal peak and whose actual value may not be very sensitive, the numerical integration can indicate that the imaging-depth limit for regular 2P imaging can be reached when z_{focal}=1023 μm where (S/B)₂ₚ=1. Element 505, the area under the curve, can be the integrated in-focus signal with an exemplary width of 2 μm. Element 510, the area with the z less than focus, can be the integrated out-of-focus background. The exemplary signal curve has been normalized to the peak value of the exemplary signal. (See, e.g., FIG. 5A). This result can be very close to the experimentally measured value of, for example, about 1 mm for brain tissues. (See, e.g., Reference 8).

### 3.3. SB Improvement and Depth Extension of STEAM.

According to Eq. (6), the exemplary system, method and computer-accessible medium, according to an exemplary embodiment of the present disclosure, can be an overall three-photon non-linear process. By assuming uniformly stained sample and uniformly distributed laser intensity in each z layer, Eq. (6) can be modified into, for example, as follows:

$$\begin{matrix}{( \frac{S}{B} )}_{STEAM} \approx \frac{{\int }_{{z}_{in}}^{ } {\int }_{0}^{r ( z )} {I}_{ballistic}^{3} ( r , z ) d r d z}{{\int }_{{z}_{out}}^{ } {\int }_{0}^{r ( z )} {I}_{ballistic}^{3} ( r , z ) d r d z} \\ \approx \frac{{\int }_{{z}_{in}}^{ } [ {( \frac{{P}_{ballistic} ( z )}{A ( z )} )}^{3} A ( z ) ] d z}{{\int }_{{z}_{out}}^{ } [ {( \frac{{P}_{ballistic} ( z )}{A ( z )} )}^{3} A ( z ) ] d z}\end{matrix} \qquad ( 12 )$$

By defining Q(z)_{STEAM}≡[P_{ballistic}(z)/A(z)]³ A(z), the following, for example, can be obtained,

$${Q ( z )}_{STEAM} ∝ \frac{exp ( - 3 z / {L}_{s} )}{{( 1 + {[ ( z - {z}_{focal} ) / {z}_{R} ]}^{2} )}^{2}} \qquad ( 13 )$$

Similar numerical integration can be performed for the exemplary system, method and computer-accessible medium as in the 2P imaging described in Eq. (11). FIG. 5B illustrates that, e.g., by using the exemplary system, method and computer-accessible medium, (S/B)_{STEAM}=1 can be reached at a new depth limit of z_{focal}=1885 μm. This can extend the original depth limit of z_{focal}=1023 μm of regular 2P imaging by more than about 1.8 times. It can also be possible to illustrate how the image contrast can diminish with the increasing depth for both regular 2P imaging and the exemplary system, method and computer-accessible medium. The exemplary system, method and computer-accessible medium, according to an exemplary embodiment of the present disclosure, can achieve, for example, a 46 times of S/B contrast improvement when imaging at regular 2P depth limit of z_{focal}=1023 μm.

The dependence (S/B)₂ₚ can be a function of the focal depth z_{focal} between 1000-2000 μm. At the exemplary depth limit of the exemplary system, method and computer-accessible medium, which can be 1885 μm, (S/B)₂ₚ may only be 0.001. (See, e.g., FIG. 5C). In contrast, when at the standard 2P depth limit of 1023 μm, (S/B)_{STEAM} can be 46, which can be much higher than the corresponding (S/B)₂ₚ=1 at this exemplary focal depth. (See, e.g., FIG. 5D).

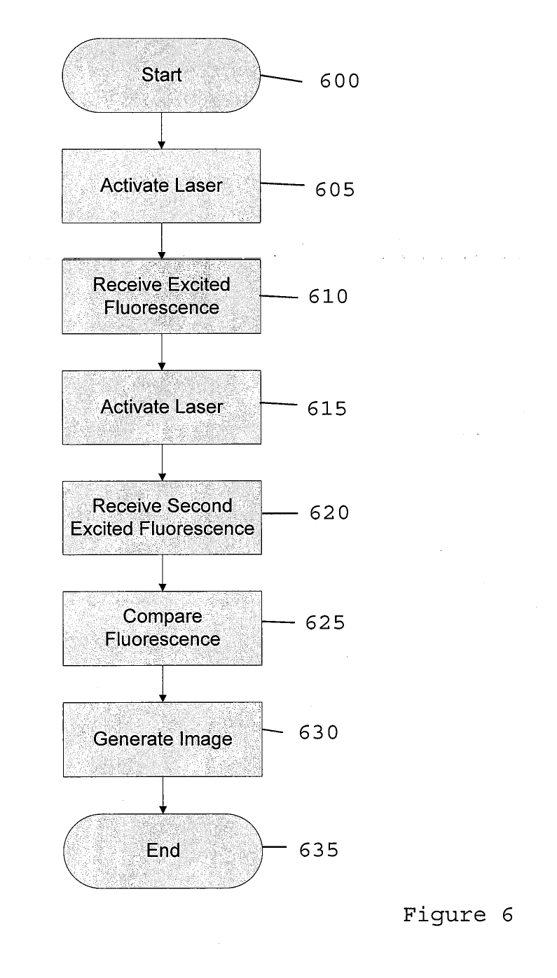

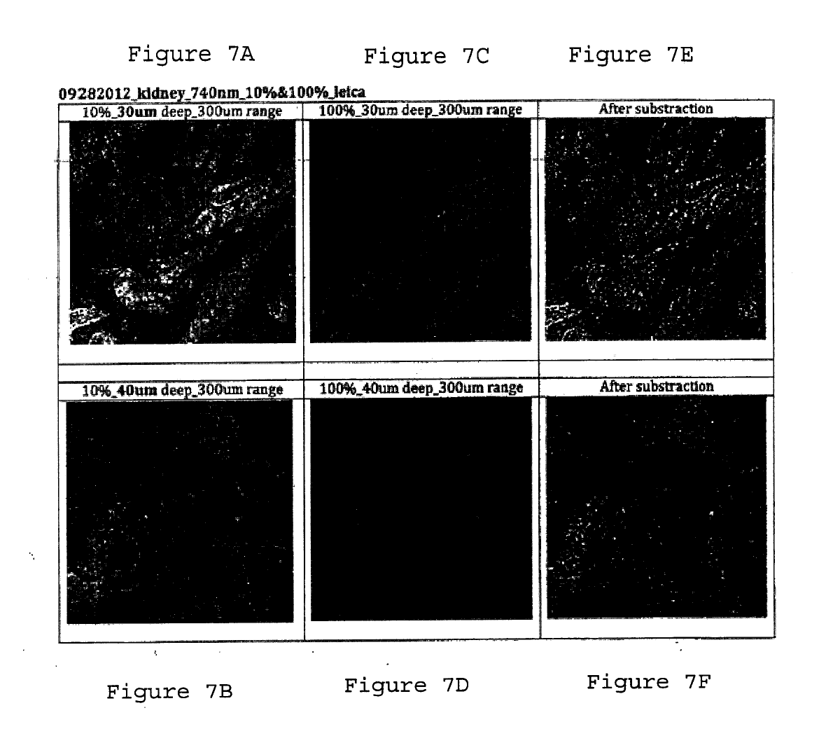

FIG. 6 shows an exemplary flow diagram of a process/method for generating an image using stimulated emission fluorescence microscopy, according to another exemplary embodiment of the present disclosure. The exemplary process/method can begin at block 600. At procedure 605, a laser can be activated to stimulate a fluorescence excitation in the object to be imaged corresponding to both the in-focus and the out-of-focus areas of the object. At procedure 610, the fluorescence excitation generated from the first laser activation can be received and stored for later use. (See, e.g., FIGS. 7A and 7B). At procedure 615, the same laser, or a combination of the same laser and a different laser, can be activated. If the same laser can be activated at procedures 605 and 615, then a two-photon laser can be used, and the laser can be activated at different intensities. For example, the two-photon laser can first be activated at a low intensity at procedure 605 and then activated at a higher intensity at procedure 615. Alternatively, the two-photon laser can be activated at a high intensity at procedure 605 and then activated at a lower intensity at procedure 615. The second laser activation can generate an excited fluorescence in both the in-focus and out-of-focus areas and can take advantage of the property that a linear change in intensity of the laser does not result in a linear change in the excitation of both the in-focus and out-of-focus areas (e.g., the excitation change in the in-focus area can increase less than the change in the out-of-focus area when the intensity can be increased, or vice versa when the intensity can be decreased).

If a different laser can be activated at procedures 605 and 615, then the two-photon laser can be activated at procedure 605, and both the two-photon laser and a stimulated emission laser can be activated at procedure 615. At procedure 620, a second excitation can be received and stored (See, e.g., FIGS. 7C and 7D). If a single laser can be used at procedures 605 and 615, then the second excitation can be generated from only the second laser activation. If a different laser can be activated at procedure 615 than the laser activated at procedure 605, the second excitation can be generated from a combination of the first laser and the second laser. For example, the first laser can remain on at procedure 615, and both the first laser and the second laser can be active at the same time, deactivating the in-focus area, and leaving only the out-of-focus area stimulated.

At procedure 625, the first excited fluorescence and the second excited fluorescence can be compared to generate an image at procedure 630 (See, e.g., FIGS. 7E and 7F). The comparison can include a subtraction of the second excited fluorescence (e.g., which can be composed of only the out-of-focus area) from the first excited fluorescence (e.g., which can be composed of both the in-focus and out-of-focus area) to generate an image only having the in-focus area, or the subtraction can include a subtraction of the first excited fluorescence from the second excited fluorescence. Alternatively, the comparison can include a division of the first excited fluorescence by the second excited fluorescence or a division of the second excited fluorescence by the first excited fluorescence. At block 635, the exemplary process/method can end, and the image can be stored for later use.

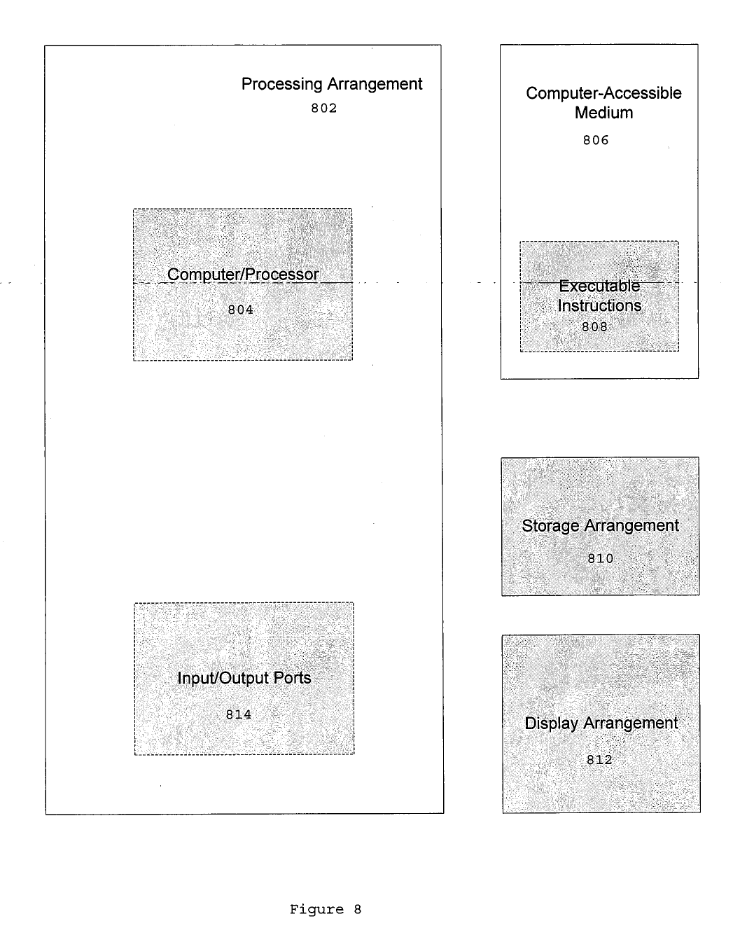

FIG. 8 shows a block diagram of an exemplary embodiment of a system according to the present disclosure. For example, exemplary procedures in accordance with the present disclosure described herein can be performed by a processing arrangement and/or a computing arrangement 802. Such processing/computing arrangement 802 can be, for example, entirely or a part of, or include, but not limited to, a computer/processor 804 that can include, for example, one or more microprocessors, and use instructions stored on a computer-accessible medium (e.g., RAM, ROM, hard drive, or other storage device).

As shown in FIG. 8, for example, a computer-accessible medium 806 (e.g., as described herein above, a storage device such as a hard disk, floppy disk, memory stick, CD-ROM, RAM, ROM, etc., or a collection thereof) can be provided (e.g., in communication with the processing arrangement 802). The computer-accessible medium 806 can contain executable instructions 808 thereon. In addition or alternatively, a storage arrangement 810 can be provided separately from the computer-accessible medium 806, which can provide the instructions to the processing arrangement 802 so as to configure the processing arrangement to execute certain exemplary procedures, processes and methods, as described herein above, for example.

Further, the exemplary processing arrangement 802 can be provided with or include an input/output arrangement 814, which can include, for example, a wired network, a wireless network, the interne, an intranet, a data collection probe, a sensor, etc. As shown in FIG. 8, the exemplary processing arrangement 802 can be in communication with an exemplary display arrangement 812, which, according to certain exemplary embodiments of the present disclosure, can be a touch-screen configured for inputting information to the processing arrangement in addition to outputting information from the processing arrangement, for example. Further, the exemplary display 812 and/or a storage arrangement 810 can be used to display and/or store data in a user-accessible format and/or user-readable format.

### 4. Further Exemplary Discussion

It has been thought to extend the depth limit of previously known 2P microscopy by detecting three-photon, or four-photon, excited fluorescence signal. However, this seemingly viable approach may not be practically attractive for bio-imaging, because (1) the simultaneous three-photon, or four- photon, absorption via more virtual states can be an extremely improbable event; the transition amplitude can be determined by the fifth, or seventh, order nonlinear molecular polarizability, and (2) the laser excitation wavelength for the classic GFP, yellow fluorescent protein (“YFP”) and red fluorescent protein (“RFP”) can be longer than 1400 nm, which can lie outside the transparent optical window (e.g., 650-1300 nm) of most biological tissues. In contrast, the exemplary system, method and computer-accessible medium, according to an exemplary embodiment of the present disclosure, can operate through the real excited state of the fluorophore and all the involved wavelengths can be within the transparent optical window.

Although the exemplary system, method and computer-accessible medium according to the exemplary embodiments of the present disclosure can employ a separate CW laser beam for SE, it can also be used to perform single wavelength experiment with the proper fluorophores (e.g., single-wavelength STED has been recently demonstrated on ATT0647N). (See, e.g., Reference 19). In such a case, the 2P excitation wavelength can lie within the fluorescence emission spectrum of the fluorophores. For example, the output of a femtosecond pulsed laser can be separated into two arms, and one of the pulse trains can be stretched into long pulses to act as the CW beam for SE

The exemplary system, method and computer-accessible medium according to exemplary embodiments of the present disclosure for the fluorescence microscopy, can extend the fundamental depth limit of 2P imaging. The exemplary system, method and computer-accessible medium can be different from the existing procedures that focus on methods of reducing scattering loss of the incident light. The exemplary system, method and computer-accessible medium according to exemplary embodiments of the present disclosure can be advantageous in that, for example, approximately 1.8-times deeper imaging depth can be achieved for scattering samples such as brain tissues.

Any and all references specifically identified in the specification of the present application are expressly incorporated herein in their entirety by reference thereto. The term “about,” as used herein, should generally be understood to refer to both the corresponding number and a range of numbers. Moreover, all numerical ranges herein should be understood to include each whole integer within the range.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure, including using the features and various exemplary embodiments described herein together and interchangeably with one another. In addition, all publications and references referred to above can be incorporated herein by reference in their entireties. It should be understood that the exemplary procedures described herein can be stored on any computer-accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated in their entirety.
1. S. W. Hell, “Far-field optical manoscopy,” Science 316, 1153-8 (2007).
2. B. Huang, H. Babcock, and X. Zhuang, “Breaking the diffraction barrier: super-resolution imaging of cells,” Cell 143, 1047-58 (2010).
3. E. Betzig, G. H. Patterson, R. Sougrat, 0. W. Lindwasser, S. Olenych, J. S. Bonifacino, M. W. Davidson, J. Lippincott-Schwartz, and H. F. Hess, “Imaging intracellular fluorescent proteins at nanometer resolution,” Science 313, 1642-5 (2006).
4. W. Denk, J. H. Strickler, and W. W. Webb, “Two-photon laser scanning fluorescence microscopy,” Science 248, 73-76 (1990).
5. F. Helmchen and W. Denk, “Deep tissue two-photon microscopy,” Nat. Methods 2, (2005).
6. R. Yuste, Ed., “Imaging: A laboratory manual,” Cold Spring Harbor Laboratory Press (2010).
7. P. Theer and W. Denk, “On the fundamental imaging-depth limit in two-photon microscopy,” J. Opt. Soc. Am. A-Opt. Image Sci. Vis. 23, 3139-49 (2006).
8. P. Theer, M. T. Hasan, and W. Denk, “Two-photon imaging to a depth of 1000 micron in living brains by use of a Ti:Al2O3 regenerative amplifier,” Opt. Lett. 28, 1022-4 (2003).
9. D. Kobat, N. G. Horton, and C. Xu, “In vivo two-photon microscopy to 1.6-mm depth in mouse cortex,” J. Biomed. Opt. 16, 106014 (2011).
10. N. J. Durr, C. T. Weisspfennig, B. A. Holfeld, and A. Ben-Yakar, “Maximum imaging depth of two- photon autofluorescence microscopy in epithelial tissues,” J. Biomed. Opt. 16, 026008 (2011).
11. J. Ying, F. Liu, and R. R. Alfano, “Spatial distribution of two-photon-excited fluorescence in scattering media,” Appl. Opt. 38, 224-9 (1999).
12. N. Ji, D. E. Milkie, and E. Betzig, “Adaptive optics via pupil segmentation for high-resolution imaging in biological tissues,” Nat. methods 7, 141-7 (2010).
13. M. Rueckel, J. A. Mack-Bucher, and W. Denk, “Adaptive wavefront correction in two-photon microscopy using coherence-gated wavefront sensing,” Proc. Natl. Acad. Sci. USA 103, 17137-42 (2006).
14. Z. Yaqoob, D. Psaltis, M. S. Feld, and C. Yang, “Optical Phase Conjugation for Turbidity Suppression in Biological Samples,” Nature photon. 2, 110-115 (2008).
15. A. Leray, K. Lillis, and J. Mertz, “Enhanced background rejection in thick tissue with differential-aberration two-photon microscopy,” Biophys. J. 94, 1449-1458 (2008).
16.W. Min, S. Lu, S. Chong, R. Roy, G. R. Holtom, and X. S. Xie, “Imaging chromophores with undetectable fluorescence by stimulated emission microscopy,” Nature 461, 1105-9 (2009).
17. W. Min, “Label-free optical imaging of nonfluorescent molecules by stimulated radiation,” Curr. Opin. Chem. Biol. 15, 831-7 (2011).
18. J. B. Ding, K. T. Takasaki, and B. L. Sabatini, “Supraresolution imaging in brain slices using stimulated-emission depletion two-photon laser scanning microscopy,” Neuron 63, 429-37 (2009).
19. P. Bianchini, B. Harke, S. Galiani, G. Vicidomini, and A. Diaspro, “Single-wavelength two-photon excitation-stimulated emission depletion (SW2PE-STED) superresolution imaging,” Proc. Natl. Acad. Sci. USA (2012).
20. S. Hell, “Microscopy and its focal switch,” Nat. Methods 6, (2008)

1. A non-transitory computer-accessible medium having stored thereon computer-executable instructions for imaging at least one portion of at least one object, wherein, when a computer hardware arrangement executes the instructions, the computer arrangement is configured to perform procedures comprising:
receiving a first information corresponding to a first excited fluorescence of the at least one portion of the at least one object;
receiving a second information corresponding to a second excited fluorescence of the at least one portion of the at least one object; and
determining a third information based on the first information and the second information.

2. The computer-accessible medium of claim 1, wherein the computer arrangement is further configured to generate (i) the first excited fluorescence using a first radiation arrangement, and (ii) the second excited fluorescence via a combination of the first radiation arrangement and a second radiation arrangement.

3. The computer-accessible medium of claim 2, wherein the first radiation arrangement includes a two-photon laser.

4. The computer-accessible medium of claim 2, wherein the second radiation arrangement includes a stimulated emission laser.

5. The computer-accessible medium of claim 4, wherein the stimulated emission laser includes at least one of a continuous wave stimulated emission laser or a pulsed stimulated emission laser.

6. The computer-accessible medium of claim 1, wherein the computer hardware arrangement is further configured to generate (i) the first excited fluorescence using a radiation arrangement at a first intensity, and (ii) the second excited fluorescence using the radiation arrangement at a second intensity.

7. The computer-accessible medium of claim 6, wherein the first intensity is higher than the second intensity.

8. The computer-accessible medium of claim 6, wherein the first intensity is lower than the second intensity.

9. The computer-accessible medium of claim 6, wherein the radiation arrangement includes a two-photon laser.

10. The computer-accessible medium of claim 1, wherein the computer arrangement is further configured to determine the third information by at least one of subtracting the second information from the first information or subtracting the first information from the second information.

11. The computer-accessible medium of claim 1, wherein the computer arrangement is further configured to determine the third information by at least one of dividing the first information by the second information or dividing the second information by the first information.

12. The computer-accessible medium of claim 1, wherein the first information and the second information are generated using a multi-photon microscope.

13. The computer-accessible medium of claim 12, wherein the multi-photon microscope includes a widely tunable pulsed laser.

14. The computer-accessible medium of claim 2, wherein the computer arrangement is further configured to determine the third information using a lock-in amplifier and a modulator which are configured to block and unblock a radiation generated by the second radiation arrangement at a particular frequency.

15. A method of generating an image of at least one object using a fluorescence microscopy procedure, comprising:
providing a first radiation, and receiving a first excited fluorescence of the at least one object based on the first radiation;
providing a second radiation, and receiving a second excited fluorescence of the at least one object based at least in part on the second radiation; and
with a computer hardware arrangement, generating an image of the at least one object based on the first excited fluorescence and the second excited fluorescence.

16. The method of claim 15, further comprising generating (i) the first radiation using a first radiation arrangement, and (ii) the second radiation via a combination of the first radiation arrangement and a second radiation arrangement.

17-19. (canceled)

20. The method of claim 15, further comprising generating (i) the first radiation using a radiation arrangement at a first intensity, and (ii) the second radiation using the radiation arrangement at a second intensity.

21. The method of claim 20, wherein the first intensity is higher than the second intensity.

22-23. (canceled)

24. The method of claim 15, wherein the generation procedure includes at least one of subtracting the second excited fluorescence from the first excited fluorescence or subtracting the first excited fluorescence from the second excited fluorescence.

25. The method of claim 15, wherein the generation procedure includes at least one of dividing the first excited fluorescence by the second excited fluorescence or dividing the second excited fluorescence by the first excited fluorescence.

26-27. (canceled)

28. The method of claim 16, wherein the generation procedure includes blocking and unblocking the second radiation at a particular frequency using a lock-in amplifier and a modulator.

29. A system for generating an image of at least one object, comprising:
at least one radiation providing arrangement configured to provide a first radiation and a second radiation;
an optical arrangement configured to receive a first excited fluorescence based on the first radiation and a second excited fluorescence based, at least in part, on the second radiation; and
a computer hardware arrangement configured to generate an image based on the first excited fluorescence and the second excited fluorescence.

30. The system of claim 29, wherein the at least one radiation providing arrangement includes a first radiation providing arrangement and a second radiation providing arrangement, and wherein the first radiation is provided by the first radiation providing arrangement and the second radiation is provided by a combination of the first radiation providing arrangement and the second radiation providing arrangement.

31-33. (canceled)

34. The system of claim 29, wherein the at least one radiation providing arrangement is configured to provide the first radiation at a first intensity and to provide the second radiation at a second intensity.

35. The system of claim 34, wherein the first intensity is higher than the second intensity.

36-37. (canceled)

38. The system of claim 29, wherein the computer hardware arrangement is configured to generate the image by at least one of subtracting the second excited fluorescence from the first excited fluorescence or subtracting the first excited fluorescence from the second excited fluorescence.

39. The system of claim 29, wherein the computer arrangement is configured to generate the image by at least one of dividing the second excited fluorescence by the first excited fluorescence or dividing the first excited fluorescence by the second excited fluorescence.

40-41. (canceled)

42. The system of claim 29, wherein the computer hardware arrangement is configured to generate the image by blocking and unblocking the second radiation at a particular frequency using a lock-in amplifier and a modulator.
